(19) United States
(12) Patent Application Publication
(10) Pub. No.: US 2009/0029149 A1
(43) Pub. Date: Jan. 29, 2009

(54) PLASTIC SUBSTRATE AND METHOD OF FORMING THE SAME

(75) Inventors: Gi-Heon KIM, Daejeon (KR); Chul-Am Kim, Seoul (KR); Kyung-Soo Seo, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/112,627

(22) Filed: Apr. 30, 2008

(30) Foreign Application Priority Data
Jul. 26, 2007 (KR) 10-2007-0074981

(51) Int. Cl. B32B 5/16; B05D 1/36; B32B 9/04; B32B 27/28; B32B 27/06; B32B 15/04

(52) U.S. Cl. 428/323; 427/402; 428/688; 428/447; 428/457; 428/412; 428/473.5; 428/500

(57) ABSTRACT

Provided are a plastic substrate and a method of forming the same. The method includes coating a mixture including an inorganic material and an organic material on an organic substrate to form a coating layer. A protective layer including an inorganic layer and an organic layer is formed from the coating layer.

### CROSS-REFERENCE TO RELATED APPLICATIONS

This U.S. non-provisional patent application claims priority under 35 U.S.C. §119 of Korean Patent Application No. 10-2007-0074981, filed on Jul. 26, 2007, the entire contents of which are hereby incorporated by reference.

### BACKGROUND OF THE INVENTION

The present invention disclosed herein relates to a flexible substrate, and more particularly, to a flexible substrate having a protective layer that prevents moisture and oxygen from penetrating into the substrate.

The present invention has been derived from research undertaken as a part of IT R & D program of the Ministry of Information and Communication and Institution of Information Technology Association (MIC/IITA) [2005-S-070-03], integrated development of flexible display.

Examples of flat panel displays (FPDs) include plasma display panels (PDPs), liquid crystal displays (LCDs), and FPDs using organic light emitting diodes (OLEDs).

There has been developed a flexible device having flexible characteristics. A flat panel display using an inorganic substrate such as a typical glass substrate does not have the flexible characteristics. Thus, the flat panel display having inflexible characteristics is not fabricated for the flexible device. On the other hand, a plastic substrate containing polyethylene terephthalate (PET) and an organic material has the flexible characteristics to allow the plastic substrate to embody the flexible device.

However, the plastic substrate containing the organic material is susceptible to moisture and oxygen. To solve this limitation, an inorganic material is deposited on the plastic substrate using physical and chemical vapor deposition (PVD/CVD). However, in case where a vacuum evaporation method is used for forming a protective layer protecting the substrate from the moisture and the oxygen, process time and process cost increase. Furthermore, in case where an inorganic layer is used as the protective layer, an organic layer is further formed on the inorganic layer so as to protect the inorganic layer from the outside.

### SUMMARY OF THE INVENTION

The present invention provides a plastic substrate having a protective layer that can prevent moisture and oxygen from penetrating into the substrate.

Embodiments of the present invention provide methods of forming a plastic substrate including coating a mixture including an inorganic material and an organic material on an organic substrate to form a coating layer; and forming a protective layer including an inorganic layer and an organic layer from the coating layer.

In other embodiments of the present invention, plastic substrates include an inorganic layer on an organic substrate; and an organic layer on the inorganic layer, wherein the inorganic layer and the organic layer are formed using a wet coating process.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIGS. 1 through 3 are cross-sectional views illustrating a process of forming a plastic substrate according to an embodiment of the present invention; and

FIG. 4 is a cross-sectional view illustrating a modification example of the plastic substrate according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the figures, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

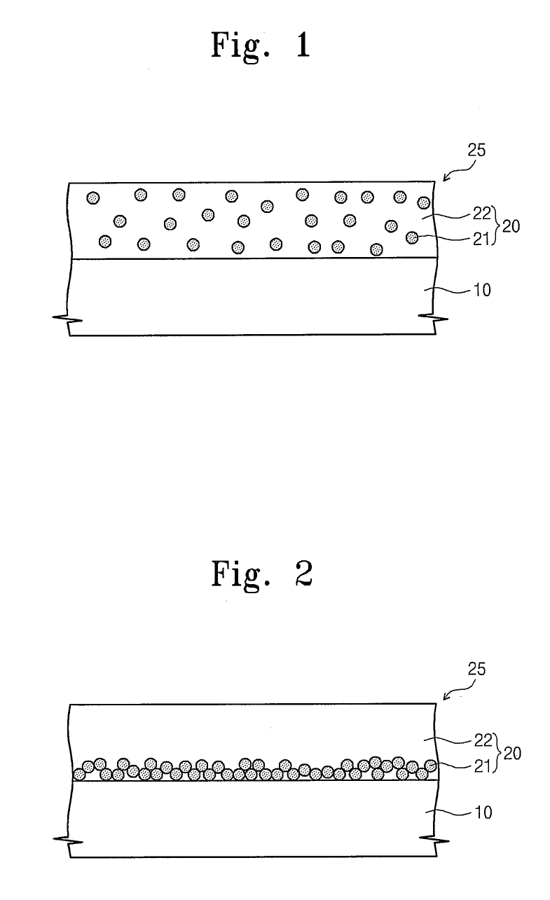

Referring to FIGS. 1 through 3, a process of forming a plastic substrate according to an embodiment of the present invention will be described below.

Referring to FIG. 1, a mixture 20 is coated on an organic substrate 10 to form a coating layer 25. The mixture is coated by a wet coating process. The wet coating process includes a bar coating process, a spin coating process, or dip coating process.

The organic substrate 10 includes at least one of polyethylene terephthalate (PET), polyethylene naphthalate (PEN), polyetheretherketone (PEEK), polycarbonate (PC), polyimide (PI), polyether sulfone (PES), polyarylite and cyclic olefin copolymer (COC).

The mixture 20 includes an inorganic material 21 a dispersion medium 22 surrounding the inorganic material 21. The dispersion medium 22 includes an organic material and a solvent. The organic material includes a polymer, a reactive monomer, or an oligomer. The dispersion medium 22 does not include the solvent when the organic material is formed of the reactive monomer or the oligomer. The dispersion medium 22 includes a polymerization initiator that induces polymerization of the reactive monomer or the oligomer. The solvent may be an organic solvent in which the organic material is soluble.

The inorganic material 21 may be a material having higher visible light transmission. For example, the inorganic material 21 includes at least one of silicone oxide, titanium oxide, silicone nitride, silicone, smectite, kaolinite, dickite, nacrite, halloysite, antigorite, chrysotile, pyrophyllite, montmorillonite, hectorite, tetrasilicicmica, sodiumtaeniolite, muscovite, margarite, talc, vermiculite, phlogopite, xanthophyllite, and chlorite.

An average particle diameter of the inorganic material 21 is smaller than a wavelength (from about 400 to about 700 nm) of a visible light ray. For example, the average particle diameter of the organic material 21 is less than about 100 nm, and preferably, less than 50 nm. The inorganic material 21 is present in an amount ranging from about 5 wt % to about 90 wt %, preferably from about 10 wt % to about 80 wt % of the mixture 20. An inorganic layer may not be completely formed when the inorganic material 21 is less than about 5 wt % of the mixture 20. The inorganic material 21 may not be uniformly dispersed within the mixture to decrease reliability of a protective layer (reference numeral 30 of FIG. 3) when the inorganic material 21 is over about 90 wt % of the mixture 20.

The polymer includes at least one of an amide-based resin, an acrylic-based resin, a cellulose-based resin, a halogen-contained resin, and a hydrogen bonding resin. The polymer includes at least one of low density polyethylene, high density polyethylene, ethylene-propylene copolymer, ethylene-butene copolymer, ethylene-hexen copolymer, ethylene-octene copolymer, ethylene-norbornene copolymer, ethylene-demon copolymer, polypropylene, ethylene-acetic vinyl copolymer, ethylene-methyl methacrylate copolymer, polyester (nylon-6, nylon-6,6, metaxylenediamine-adipate condensation polymer), polymethylmethacrylimide, polymethylmethacrylate, polystyrene, styrene-acrylonitrile copolymer, styrene-acrylonitrile-butadiene copolymer, cellulose triacetate, cellulose diacetate, polyvinyl chloride, polyvinylidene chloride, polyvinylidene fluoride, polytetrafluoroethylene, polyvinyl alcohol, ethylene-vinyl alcohol copolymer, cellulose derivatives, polycarbonate, polysulfone, polyethersulfone, polyetheretherketone, polyphenylene oxide, polymethylene oxide, polyimide, polyarylate, and polysiloxane.

The reactive monomer or the oligomer includes at least one of acrylic-based hydrocarbon, aromatic-based hydrocarbon, acrylonitrile-based hydrocarbon, and chloride (CI)-based hydrocarbon. The reactive monomer or the oligomer includes at least one of triethylopropane triacrylate (TEPTA), tri(propylene glycol) diacrylate (TPGDA), penthaerithritol triacrylate (PETA), trimethylolpropane ethoxylate triacrylate (TMPEOTA), methyl methacrylate (MMA), methacrylate (MA), tri(propylene glycol) glycerolate diacrylate (TPGGDA), vinylacrylate (VA), styrene (ST), divinyl benzene (DVB), acrylonitrile (AN), vinylidene chloride (VDC), vinylbenzyl chloride (VBC), vinyl stearate (VS), vinyl propionate (VP), polyfunctional siloxane, and polyfunctional silicone.

The polymerization initiator includes at least one of a photo initiator, a thermal initiator, a redox initiator, and an oxidation initiator. The photo initiator includes at least one of 1-hydroxy-cyclohexyl-phenyl-ketone (Irgacure 907), 2-methyl-1[4-(methylthio)phenyl]-2-morpholinopropane-1-one (Irgacure 184C), 2-hydroxy-2-methl-1-phenyl-propan-1-one (Darocur 1173), a mixed initiator (Irgacure 500) of Irgacure 184C and benzophenone, a mixed initiator (Irgacure 1000) of Irgacure 184C and Irgacure 1173, 2-hydroxy-1-[4-(2-hydroxyethoxy)phenyl]-2-methyl-1propanone (Irgacure 2959), methylbenzoylformate (Darocure MBF), α,α-dimethoxy-α-phenylacetophenone (Irgacure 651), 2-benzyl-2-(dimethylamino)-1-[4-(4-morpholinyl)phenyl]-1-butanone (Irgacure 369), a mixed initiator (Irgacure 1300) of Irgacure 369 and Irgacure 651, diphenyl(2,4,6-trimethylbenzoyl)-phosphine oxide (Darocur TPO), a mixed initiator (Darocur 4265) of Darocur TPO and Darocur 1173, phosphine oxide, phenyl bis(2,4,6-trimethyl benzoyl) (Irgacure 819), a mixed initiator (Irgacure 2005) of Irgacure 819 and Darocur 1173, a mixed initiator (Irgacure 2010) of Irgacure 819 and Darocur 1173, and a mixed initiator (Irgacure 2020) of Irgacure 819 and Darocur 1173, bis(η5-2,4-cyclopentadien-1-yl)bis[2,6-difluoro-3-(1H-pyrrol-1-yl)phenyl]titanium(Irgacure 784), and a mixed initiator (HSP 188) containing benzophenene. The thermal initiator includes at least one of benzoyl peroxide (BP), acetyl peroxide (AP), diauryl peroxide (DP), di-tert-butyl peroxide (t-BTP), cumyl hydroperoxide (CHP), hydrogen peroxide (HP), potassium peroxide (PP), 2,2′-azobisisobutyronitrile (AIBN), and azocompound. The redox initiator includes at least one of silver alkyls and persulfate (K2S208).

Referring to FIG. 2, after a predetermined time elapses, the inorganic material 21 is precipitated due to a difference in specific gravity between the inorganic material 21 and the dispersion medium 22. Therefore, the inorganic material 21 is accumulated on a surface of the organic substrate 10. The inorganic material 21 is disposed in a lower portion of the coating layer 25, and the dispersion medium 22 is disposed in an upper portion of the coating layer 25.

Referring to FIG. 3, the protective layer 30 including an inorganic layer 31 and an organic layer 32 is formed on the organic substrate 10. The inorganic material 21 is accumulated on the surface of the organic substrate 10 due to the difference between their specific gravity to form the inorganic layer 31. A portion of the organic material may remain within the inorganic material 21, and therefore, the inorganic layer 31 may include a small amount of the organic material.

The organic material remains on the inorganic layer 31 by removing the solvent included in the dispersion medium 22 to form the organic layer 32. The solvent is removed by heating the dispersion medium 22 at a temperature ranging from about 120° C. to about 150° C.

The reactive monomer or the oligomer in the dispersion medium 22 may be polymerized using the polymerization initiator to form the organic layer 32. For example, a radical formed from the reactive monomer or the oligomer is polymerized with the other reactive monomer or the other oligomer to form the organic layer 32. As described above, the inorganic layer 31 and the organic layer 32 are formed substantially simultaneously.

A thickness of the protective layer 30 is over about 0.1 μm, preferably about 1 μm. The protective layer 30 may further include additives such as an ultraviolet stabilizer, an antioxidant, and an antistatic agent.

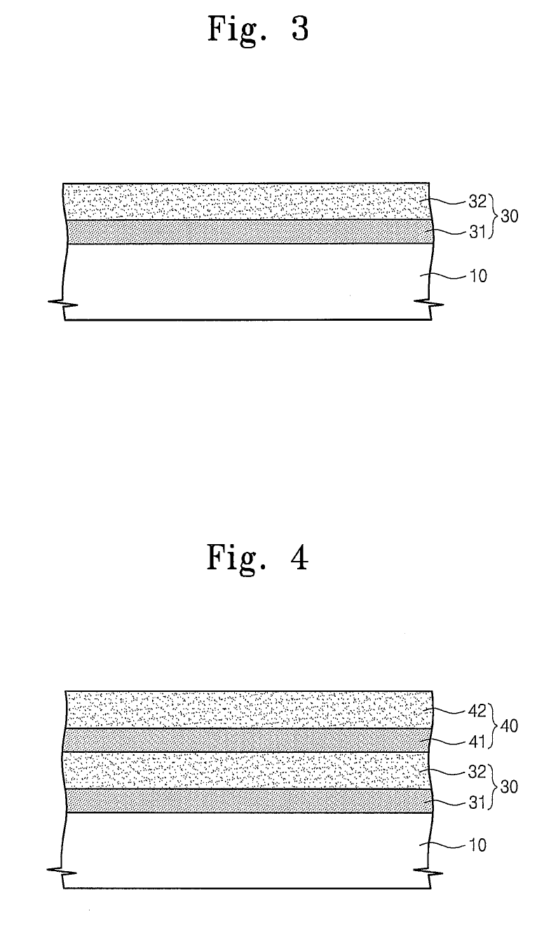

Referring to FIG. 4, a modification example of a plastic substrate according to an embodiment of the present invention will be described below. The other protective layer 40 may be disposed on the organic substrate 10 having the protective layer 30 illustrated in FIG. 3. That is, the plastic substrate according to the present invention may include at least two stacked protective layers. The protective layer 40 is formed using the same method as employed in the foregoing embodiments, and includes an inorganic layer 41 and an organic layer 42.

According to an embodiment of the present invention, a protective layer capable of preventing penetration of moisture and oxygen can be formed in a simple process and at low costs.

According to another embodiment of the present invention, a protective layer disposed on a plastic substrate prevents penetration of moisture and oxygen to enhance stability and reliability of the plastic substrate.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of forming a plastic substrate, the method comprising:
coating a mixture including an inorganic material and an organic material on an organic substrate to form a coating layer; and
forming a protective layer including an inorganic layer and an organic layer from the coating layer.

2. The method of claim 1, wherein the inorganic material comprises at least one of silicone oxide, titanium oxide, silicone nitride, silicone, smectite, kaolinite, dickite, nacrite, halloysite, antigorite, chrysotile, pyrophyllite, montmorillonite, hectorite, tetrasilicicmica, sodiumtaeniolite, muscovite, margarite, talc, vermiculite, phlogopite, xanthophyllite, and chlorite.

3. The method of claim 1, wherein the inorganic material is present in an amount ranging from about 5 wt % to about 90 wt % of the mixture.

4. The method of claim 1, wherein the mixture is coated using a wet coating process, the wet coating process comprising a bar coating process, a spin coating process, or a dip coating process.

5. The method of claim 1, wherein forming the protective layer comprises:
accumulating the inorganic material in the mixture on a surface of the organic substrate to form the inorganic layer; and
forming the organic layer from the organic material on the inorganic layer.

6. The method of claim 5, wherein, after a predetermined time elapses, the inorganic material is accumulated on the surface of the organic substrate due to a difference in specific gravity between the inorganic material and the organic material.

7. The method of claim 5, wherein the mixture comprises a solvent in which the organic material is soluble, and forming the organic layer comprises removing the solvent.

8. The method of claim 7, wherein the organic material comprises a polymer, the polymer being a thermoplastic resin.

9. The method of claim 8, wherein the polymer comprises at least one of an amide-based resin, an acrylic-based resin, a cellulose-based resin, a halogen-contained resin, and a hydrogen bonding resin.

10. The method of claim 8, wherein the polymer comprises at least one of low density polyethylene, high density polyethylene, ethylene-propylene copolymer, ethylene-butene copolymer, ethylene-hexen copolymer, ethylene-octene copolymer, ethylene-norbornene copolymer, ethylene-demon copolymer, polypropylene, ethylene-acetic vinyl copolymer, ethylene-methyl methacrylate copolymer, polyester (nylon-6, nylon-6,6, metaxylenediamine-adipate condensation polymer), polymethylmethacrylimide, polymethylmethacrylate, polystyrene, styrene-acrylonitrile copolymer, styrene-acrylonitrile-butadiene copolymer, cellulose triacetate, cellulose diacetate, polyvinyl chloride, polyvinylidene chloride, polyvinylidene fluoride, polytetrafluoroethylene, polyvinyl alcohol, ethylene-vinyl alcohol copolymer, cellulose derivatives, polycarbonate, polysulfone, polyethersulfone, polyetheretherketone, polyphenylene oxide, polymethylene oxide, polyimide, polyarylate, and polysiloxane.

11. The method of claim 5, wherein the organic material comprises at least one of a reactive monomer and an oligomer,
the mixture comprises a polymerization initiator, and
forming the organic layer comprises inducing polymerization of the reactive monomer or the oligomer using the polymerization initiator.

12. The method of claim 11, wherein the reactive monomer or the oligomer comprises at least one of acrylic-based hydrocarbon, aromatic-based hydrocarbon, acrylonitrile-based hydrocarbon, and chloride (CI)-based hydrocarbon.

13. The method of claim 11, wherein the reactive monomer or the oligomer comprises at least one of triethylopropane triacrylate(TEPTA), tri (propylene glycol) diacrylate(TPGDA), penthaerithritol triacrylate(PETA), trimethylolpropane ethoxylate triacrylate(TMPEOTA), methyl methacrylate(MMA), methacrylate(MA), tri(propylene glycol) glycerolate diacrylate(TPGGDA), vinylacrylate(VA), styrene, divinyl benzene(DVB), acrylonitrile(AN), vinylidene chloride(VDC), vinylbenzyl chloride(VBC), vinyl stearate(VS), vinyl propionate(VP), polyfunctional siloxane, and polyfunctional silicone.

14. The method of claim 11, wherein the polymerization initiator comprises at least one of a photo initiator, a thermal initiator, a redox initiator, and an acid initiator.

15. The method of claim 14, wherein the photo initiator comprises at least one of 1-hydroxy-cyclohexyl-phenyl-ketone (Irgacure 907), 2-methyl-1[4-(methylthio)phenyl]-2-morpholinopropane-1-one (Irgacure 184C), 2-hydroxy-2-methyl-1-phenyl propan-1-one (Darocur 1173), a mixed initiator (Irgacure 500) of Irgacure 184C and benzophenone, a mixed initiator (Irgacure 1000) of Irgacure 184C and Irgacure 1173, 2-hydroxy-1-[4-(2-hydroxyethoxy)phenyl]-2-methyl-1propanone (Irgacure 2959), methylbenzoylformate (Darocure MBF), α,α-dimethoxy-α-phenylacetophenone (Irgacure 651), 2-benzyl-2-(dimethylamino)-1-[4-(4-morpholinyl)phenyl]-1-butanone (Irgacure 369), a mixed initiator (Irgacure 1300) of Irgacure 369 and Irgacure 651, diphenyl(2,4,6-trimethylbenzoyl)-phosphine oxide (Darocur TPO), a mixed initiator (Darocur 4265) of Darocur TPO and Darocur 1173, phosphine oxide, phenyl bis(2,4,6-trimethyl benzoyl) (Irgacure 819), a mixed initiator (Irgacure 2005) of Irgacure 819 and Darocur 1173, a mixed initiator (Irgacure 2010) of Irgacure 819 and Darocur 1173, and a mixed initiator (Irgacure 2020) of Irgacure 819 and Darocur 1173, bis(η5-2,4-cyclopentadien-1-yl)bis[2,6-difluoro-3-(1H-pyrrol-1-yl)phenyl]titanium(Irgacure 784), and a mixed initiator (HSP 188) containing benzophenene,
the thermal initiator comprises at least one of benzoyl peroxide, acetyl peroxide, diauryl peroxide, di-tert-butyl peroxide, cumyl hydroperoxide, hydrogen peroxide, potassium peroxide, 2,2′-azobisisobutyronitrile, and azocompound, and
the redox initiator comprises at least one of silver alkyls and persulfate (K2S208).

16. A plastic substrate comprising:
an inorganic layer on an organic substrate; and
an organic layer on the inorganic layer,
wherein the inorganic layer and the organic layer are formed using a wet coating process.

17. The plastic substrate of claim 16, wherein the inorganic material comprises at least one of silicone oxide, titanium oxide, silicone nitride, silicone, smectite, kaolinite, dickite, nacrite, halloysite, antigorite, chrysotile, pyrophyllite, montmorillonite, hectorite, tetrasilicicmica, sodiumtaeniolite, muscovite, margarite, talc, vermiculite, phlogopite, xanthophyllite, and chlorite.

18. The plastic substrate of claim 16, wherein the organic material has an average particle diameter less than about 100 nm.

19. The plastic substrate of claim 16, wherein the organic layer comprises a polymer polymerized from at least one of a reactive monomer and an oligomer.

20. The plastic substrate of claim 16, wherein the organic substrate comprises at least one of polyethylene terephthalate(PET), polyethylene naphthalate(PEN), polyetheretherketone(PEEK), polycarbonate(PC), polyimide(PI), polyether sulfone(PES), polyarylite and cyclic olefin copolymer(COC).
